(19) United States
(12) Patent Application Publication
(10) Pub. No.: US 2026/0060304 A1
(43) Pub. Date: Mar. 5, 2026

(54) AEROSOL GENERATING DEVICE AND HEATING COMPONENT THEREOF

(71) Applicant: SMOORE INTERNATIONAL HOLDINGS LIMITED, George Town (KY)

(72) Inventors: Lei MA, Shenzhen (CN); Xingfu ZHANG, Shenzhen (CN); Hongming ZHOU, Shenzhen (CN); Rihong LI, Shenzhen (CN); Xianwu DU, Shenzhen (CN)

(21) Appl. No.: 19/383,471

(22) Filed: Nov. 7, 2025

Related U.S. Application Data
(63) Continuation of application No. PCT/CN2024/091475, filed on May 7, 2024.

(30) Foreign Application Priority Data
May 9, 2023 (CN) 202310525534.5

(51) Int. Cl. A24F 40/46; A24F 40/20; A24F 40/51

(52) U.S. Cl. CPC A24F 40/46; A24F 40/51; A24F 40/20

(57) ABSTRACT

A heating component includes: an infrared light transmitting pipe body; and a heating member for generating infrared light. The infrared light transmitting pipe body includes an opening, and the heating member is disposed in the infrared light transmitting pipe body and at least partially spaced apart from a pipe wall of the infrared light transmitting pipe body. The heating component also includes a temperature sensing member having a temperature sensing probe disposed between the heating member and the opening.

### CROSS-REFERENCE TO PRIOR APPLICATION

This application is a continuation of International Patent Application No. PCT/CN2024/091475, filed on May 7, 2024, which claims priority to Chinese Patent Application No. 202310525534.5, filed on May 9, 2023. The entire disclosure of both applications is hereby incorporated by reference herein.

### FIELD

The present application relates to the field of heat-not-burn atomization, and in particular, to an aerosol generating device and a heating component thereof.

### BACKGROUND

In the field of heat-not-burn (HNB) atomization, heating methods such as heating by either central heating elements or peripheral heating elements are generally used. It is a common practice that heating elements generate heat, and then the heat is directly transferred to an aerosol generating substrate through heat conduction. The substrates are generally atomized within 350° C., and the highest temperature of the heating elements is generally controlled within 400° C. However, in some heating elements that utilize infrared light for heating, the maximum operating temperature of the heating elements may exceed 500 degrees centigrade, and may even reach approximately 1000° C. Consequently, improper temperature control may easily cause the substrates to be over-burnt, which adversely affects the vaping experience. Therefore, the ability to sense the temperature accurately and reliably is a critical prerequisite for ensuring the vaping experience.

### SUMMARY

In an embodiment, the present invention provides a heating component, comprising: an infrared light transmitting pipe body; and a heating member configured to generate infrared light, wherein the infrared light transmitting pipe body includes an opening, and the heating member is disposed in the infrared light transmitting pipe body and at least partially spaced apart from a pipe wall of the infrared light transmitting pipe body, and wherein the heating component further comprises a temperature sensing member comprising a temperature sensing probe disposed between the heating member and the opening.

### BRIEF DESCRIPTION OF THE DRAWINGS

Subject matter of the present application will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of a three-dimensional structure of an aerosol generating device having an aerosol generating substrate according to some embodiments of the present application;

FIG. 2 is a schematic diagram of a three-dimensional structure of the aerosol generating device and the aerosol generating substrate shown in FIG. 1;

FIG. 3 is a schematic diagram of a three-dimensional structure of a heating component with a temperature sensing member located in a pipe body shown in FIG. 2;

FIG. 4 is a schematic diagram of a sectional structure of the heating component shown in FIG. 3;

FIG. 5 is a schematic diagram of a sectional structure of the heating component shown in FIG. 3 in another state;

FIG. 6 is a schematic diagram of a three-dimensional exploded structure of the heating component shown in FIG. 3;

FIG. 7 is a schematic diagram of a three-dimensional structure of a heating component with a temperature sensing member located outside a pipe body shown in FIG. 2;

FIG. 8 is a schematic diagram of a sectional structure of the heating component shown in FIG. 7;

FIG. 9 is a schematic diagram of a three-dimensional exploded structure of the heating component shown in FIG. 7;

FIG. 10 is a schematic diagram of a sectional structure of a heating member shown in FIG. 4;

FIG. 11 is a schematic diagram of a three-dimensional structure of a heating component according to some embodiments of the present application;

FIG. 12 is a schematic diagram of a sectional structure of the heating component shown in FIG. 11; and

FIG. 13 is a schematic diagram of a three-dimensional exploded structure of the heating component shown in FIG. 11.

### DETAILED DESCRIPTION

In an embodiment, the present invention provides an improved aerosol generating device and a heating component thereof.

In an embodiment, the present invention provides a heating component that includes an infrared light transmitting pipe body and a heating member configured to generate infrared light, where the pipe body includes an opening into which the heating member is inserted, and the heating member is disposed in the pipe body and is at least partially spaced apart from the pipe wall of the pipe body; and
the heating component further includes a temperature sensing member, where the temperature sensing member includes a temperature sensing probe, and the temperature sensing probe is disposed between the heating member and the opening.

In an embodiment, the heating member includes a heating base and an infrared radiating layer, where the infrared radiating layer is disposed on the heating base, and the temperature sensing probe is disposed between the heating base and the opening.

In an embodiment, the pipe body is configured to be at least partially inserted into an aerosol generating substrate, and the temperature sensing member is disposed inside the pipe body.

In an embodiment, the heating component further includes a mounting bracket, where the mounting bracket passes through the opening and is disposed in the pipe body; and the temperature sensing member further includes a temperature sensing lead connected to the temperature sensing probe, the temperature sensing lead is fixed to the mounting bracket, and the temperature sensing probe is located at one end of the mounting bracket that is far away from the opening and is higher than the end surface of the mounting bracket that is far away from the opening in a vertical direction.

In an embodiment, the heating base includes a spiral section, the heating member further includes a pin section connected to one end of the spiral section that is oriented toward the opening, and a vertical projection of the temperature sensing probe onto the axis of the pipe body at least partially overlaps with a vertical projection of the pin section onto the axis of the pipe body.

In an embodiment, the heating base includes the spiral section; the heating member further includes an electrically conductive portion and the pin section connected to one end of the spiral section that is oriented toward the opening; a first connection portion is formed between the electrically conductive portion and the pin section; and the temperature sensing probe is disposed between the first connection portion and the spiral section.

In an embodiment, the temperature sensing probe is in close contact with the inner wall of the pipe body.

In an embodiment, the temperature sensing probe is in close contact with the pin section.

In an embodiment, a portion of the temperature sensing lead that is located between the temperature sensing probe and the mounting bracket contains at least one bending section.

In an embodiment, the distance between the temperature sensing probe and the top of the heating member is greater than or equal to 8 mm and less than or equal to 20 mm.

In an embodiment, the distance between the temperature sensing probe and one end of the mounting bracket that is far away from the opening is less than or equal to 5 mm.

In an embodiment, the pipe body is configured to be at least partially inserted into the aerosol generating substrate, the temperature sensing member is disposed outside the pipe body, and the temperature sensing probe is in close contact with the outer wall of the pipe body.

In an embodiment, the pipe body includes an insertion section and a fixed section connected to the insertion section, the heating component further includes a flange, the flange is fixed to the fixed section and spaced apart from the insertion section, and the temperature sensing probe corresponds to the spacing.

In an embodiment, the distance between the temperature sensing probe and the flange is greater than or equal to 2 mm, and the distance between the temperature sensing probe and the insertion section is greater than or equal to 0 mm.

In an embodiment, the temperature sensing member includes a thermocouple or a negative temperature coefficient (NTC) temperature sensing element.

In an embodiment, an accommodating cavity configured to accommodate at least a part of the aerosol generating substrate is formed in the pipe body, and the temperature sensing probe is disposed at the bottom of the accommodating cavity or the outer side of the pipe body.

In an embodiment, the pipe body includes a first pipe body and a second pipe body that sleeves the first pipe body, the heating member is spaced between the first pipe body and the second pipe body and spaced apart from the outer wall of the first pipe body, and the temperature sensing probe is disposed on the inner wall of the second pipe body.

An aerosol generating device is further constructed, including the heating component as described in any one of the above-mentioned embodiments.

Embodiment of the present application at least has the following beneficial effects: Given that the operating temperature of the heating member can exceed 500° C., and even reach over 1000° C., by disposing the temperature sensing probe between the heating base and the opening, the temperature sensing probe can avoid temperature sensing at a high-temperature section. This allows for a more accurate and stable sensing of the heating temperature of the aerosol generating substrate, thereby enhancing the atomization effect.

To provide a clearer understanding of the technical features, objectives, and effects of the present application, specific embodiments of the present application are described with reference to the accompanying drawings. In the following description, it should be understood that orientation or position relationships indicated by the terms such as “front”, “rear”, “up”, “down”, “left”, “right”, “longitudinal”, “transverse”, “vertical”, “horizontal”, “top”, “bottom”, “inner”, “outer”, “head”, and “tail” are based on orientation or position relationships illustrated in the accompanying drawings, constructed and operated in a particular orientation, and merely intended to facilitate the description of the technical solution, instead of indicating that the device or element referred to need to have a particular orientation. Thus, such terms should not be interpreted as limiting the present application.

It should be further noted that, unless otherwise clearly specified and limited, terms such as “mounted”, “connected to”, “connected”, “fixed”, and “arranged” should be understood in a generalized manner, for example, may be understood as a fixed connection, a detachable connection, or integration; or may be understood as a mechanical connection or an electrical connection; or may be understood as a direct connection, an indirect connection via a medium, an internal communication of two elements, or a mutual relationship between two elements. When an element is referred to as being “above” or “below” another element, the element can be “directly” or “indirectly” located above the other element, or one or more intervening elements may exist. The terms such as “first”, “second”, and “third” are merely for facilitating the description of the technical solution, and should not be interpreted as indicating or implying relative importance or implicitly indicating the number of the technical features indicated. Thus, the features defined with “first”, “second”, “third”, and the like. can explicitly or implicitly include one or more of such features. A person of ordinary skill in the art may understand specific meanings of the foregoing terms in the present application according to specific situations.

In the following description, for the purpose of description rather than limitation, specific details such as a specific system structure and technology are provided to thoroughly understand embodiments of the present application. However, those skilled in the art should be aware that the present application can alternatively be implemented in other embodiments without these specific details. In other cases, detailed descriptions of known systems, devices, circuits, and methods are omitted to avoid unnecessary details hindering the description of the present application.

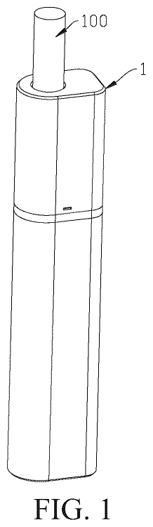

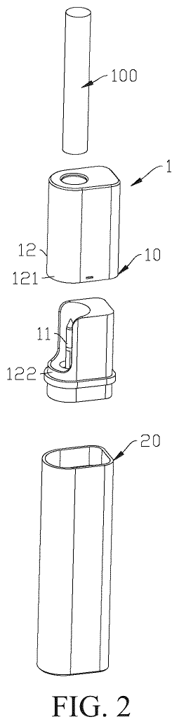

FIG. 1 and FIG. 2 show an aerosol generating device 1 according to some embodiments of the present application, where the aerosol generating device 1 may heat an aerosol generating substrate 100 in a heat-not-burn manner, and has good atomization stability and good atomization taste. In some embodiments, the aerosol generating substrate 100 may be a solid material made of leaves and/or stems of plants (such as tobacco) in strands, sheets, or integrally formed shapes, and aroma components may be further added to the solid material.

Referring to FIG. 2 again, in some embodiments, the aerosol generating device 1 may include a heating element 10 configured to heat the aerosol generating substrate 100 and a main unit 20 electrically and pluggably mounted together with the heating element 10, where the main unit 20 may be configured to be held by a consumer, and may provide electric energy required for heating the heating element 10. The aerosol generating substrate 100 is pluggably mounted in the heating element 10. Specifically, the heating element 10 is inserted into a substrate section of the aerosol generating substrate 100, and the substrate section may be heated by the heating element 10 to generate aerosol. The heating element 10 has the advantages of ease of assembly, simple structure, high atomization efficiency, high stability, and long service life.

In some embodiments, the heating element 10 may include a heating component 11 in a needle-like arrangement and a housing 12. In some embodiments, the housing 12 may include an upper housing 121 and a lower housing 122, where the upper housing 121 and the lower housing 122 jointly constitute a fixed structure configured to accommodate the heating component 11. The upper housing 121 is mounted on an upper end of the lower housing 122, and a lower end of the lower housing 122 is electrically connected to the main unit 20 in a mechanically pluggable manner.

The heating component 11 is mounted on the lower housing 122 and electrically connected to the main unit 20 by the lower housing 122, so as to implement a power-on and heating function of the heating component 11. When the aerosol generating substrate 100 is mounted on the heating element 10, the heating component 11 is inserted into a substrate section of the aerosol generating substrate 100. By an intermediate heating method, the heating component radiates light waves and transfers heat to the aerosol generating substrate 100, so as to heat and atomize the aerosol generating substrate 100, thereby achieving a more uniform atomization effect.

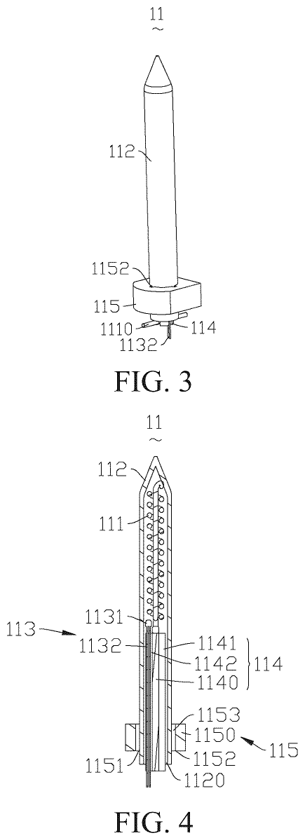

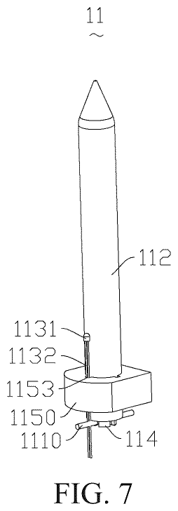

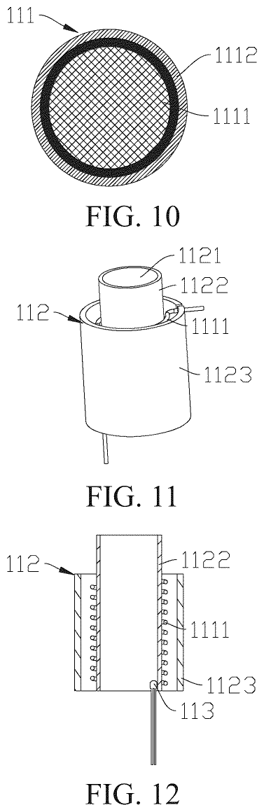

Referring to FIG. 3 to FIG. 10 together, in some embodiments, the heating component 11 may include a heating member 111 and a pipe body 112 covering the heating member 111. The heating member 111 is columnar and may be wound to form a single-spiral structure, double-spiral structure, M-shaped structure, N-shaped structure, or structure with any other shapes. Of course, it may be understood that, in some other embodiments, the number of the heating members 111 is not limited to one, which may be two or more. The shape of the heating member 111 is not limited to being columnar, and in some embodiments, the shape of the heating member 111 may be sheet-like or cylindrical. Referring to FIG. 10, the heating member 111 is mounted inside the pipe body 112. The heating member 111 includes a heating base 1111, and an infrared radiating layer 1112 is disposed outside the heating base 1111. In the case of the heating member 111 being powered on for heating, the infrared radiating layer 1112 may be configured to generate infrared light, and the infrared light is transmitted through the pipe body 112, so as to heat the aerosol generating substrate 100. The heating base 1111 is at least partially spaced from the inner wall of the pipe body 112 to prevent a large-area contact between the heating base 1111 and the pipe body 112, leading to scorching of the aerosol generating substrate 100 caused by localized overheating of the pipe body 112.

Referring to FIG. 4 to FIG. 9 together, in some embodiments, the heating component 11 further includes a temperature sensing member 113, a mounting bracket 114, and a flange 115. The temperature sensing member 113 is mounted inside or outside the pipe body 112 to perform temperature sensing on the aerosol generating substrate 100, such that the temperature at which the aerosol generating substrate 100 is heated is always controlled to be at the optimal temperature. The mounting bracket 114 is columnar, and is made of a heat-resistant and insulating hard material, such as alumina, cordierite, or zirconia. The mounting bracket 114 may be mounted inside the pipe body 112 and located below the heating base 1111. The outer diameter of the mounting bracket 114 is adapted to the inner diameter of the pipe body 112, and preferably, in an interference fit, thereby facilitating mounting the mounting bracket inside the pipe body 112. The mounting bracket 114 may be configured to fix the heating member 111 and/or the temperature sensing member 113.

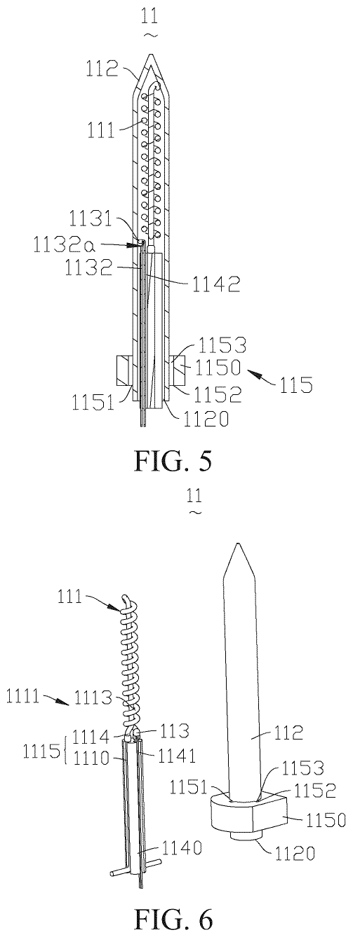

Referring to FIG. 5 together, in some embodiments, the temperature sensing member 113 may use a thermocouple or an NTC probe, where the thermocouple may be a K-type thermocouple. The temperature sensing member 113 may include a temperature sensing probe 1131 and a temperature sensing lead 1132 connected to the temperature sensing probe 1131. A portion of the temperature sensing lead 1132 that is located between the temperature sensing probe 1131 and the mounting bracket 114 contains at least one bending section 1132a, and pre-pressure is always present, such that the temperature sensing probe 1131 is in close contact with the inner wall of the pipe body 112 or a lower end of the heating base 1111, thereby enhancing temperature sensing reliability.

The temperature sensing probe 1131 is spaced apart from the top of the heating member 111 by a distance of greater than or equal to 8 mm and less than or equal to 20 mm. When the temperature sensing probe 1131 is disposed on the outer wall of the pipe body 112, insertion of the aerosol generating substrate 100 may be prevented from interfering with the temperature sensing probe 1131. When the temperature sensing probe 1131 is disposed on the inner wall of the pipe body 112, the distance may reduce the impact of high temperature from the heating base 1111, such that the temperature of the pipe wall may be truly fed back. The temperature sensing lead 1132 may be electrically connected to the main unit 20 to feed back temperature information.

The temperature sensing member 113 further includes a fixing structure and an insulation layer, where the fixing structure may be configured to prevent the temperature sensing probe 1131 of the temperature sensing member 113 from deviating. In some embodiments, the fixing structure may be disposed by using fixing glue or a guide pipe. The insulation layer may be made of glass fibers or Teflon. In some embodiments, the temperature sensing probe 1131 is in close contact with the inner wall of the pipe body 112, and is disposed between the heating base 1111 and an opening 1120 of the pipe body 112.

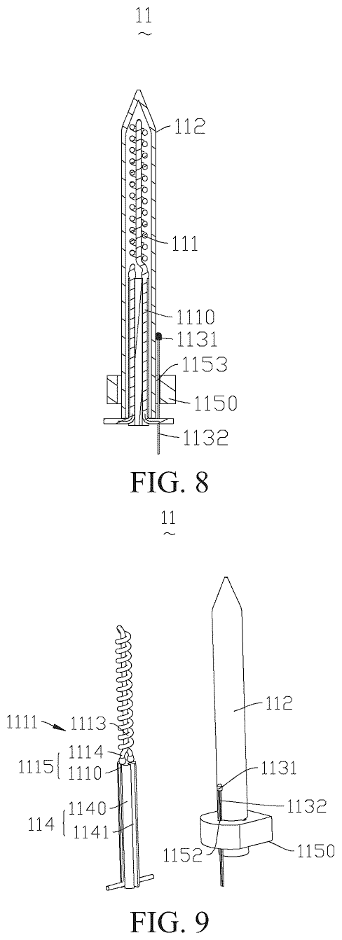

Referring to FIG. 6 and FIG. 9 together, in some embodiments, the heating base 1111 may include a spiral section 1113, the heating member 111 further includes a pin section 1114 connected to one end of the spiral section 1113 that is oriented toward the opening 1120 of the pipe body 112, and a vertical projection of the temperature sensing probe 1131 onto the axis of the pipe body 112 overlaps with a vertical projection of the pin section 1114 onto the axis of the pipe body 112, namely, in a longitudinal direction of the pipe body 112, the position of the temperature sensing probe 1131 corresponds to that of the pin section 1114. In some embodiments, the temperature sensing probe 1131 is in close contact with the pin section 1114, thereby facilitating temperature sensing of the pin section. In this embodiment, the spiral section 1113 is formed by winding a heating wire, and the pin section 1114 may be two parallel heating wires that are located at the same end of the spiral section 1113. A free end of the heating wire is approximately parallel to the axis of the spiral section 1113. The free ends of the two heating wires are respectively and electrically connected to positive and negative electrodes of a power supply as input and output ends of current. According to the heating member 111 in this embodiment, the temperature sensing sensitivity of the spiral section 1113 is relatively low, and temperature difference between the spiral section 1113 and the pipe body 112 is relatively large. Additionally, due to a narrow space around the spiral section 1113, sensing of the temperature sensing probe 1131 is easily interfered with the high temperature of the spiral section 1113, which is not conducive to timely feeding back the true heating temperature of the aerosol generating substrate. The operating temperature of the spiral section 1113 may reach over 500° C., even as high as 1000° C. Therefore, the temperature sensing probe 1131 needs to avoid a high-temperature zone of the spiral section 1113 as much as possible. In this embodiment, the temperature of the pin section 1114 is relatively low, and the temperature sensing probe 1131 may directly sense the temperature of the pin section and is configured to characterize the heating temperature of the aerosol generating substrate. Preferably, the temperature sensing probe 1131 is in close contact with the inner wall of the pipe body, where a snugly-fit position corresponds to the position of the pin section 1114, so as to more truly reflect the heating temperature of the aerosol generating substrate. It may be understood that, in some embodiments, the pin section 1114 is a part of the heating base 1111, namely, the pin section 1114 and the spiral section 1113 are wound and formed integrally, or it may be understood that the pin section 1114 and the spiral section 1113 are made of the same material.

In some embodiments, the heating component 11 may further include an electrically conductive portion 1110 connected to a lower end of the heating member 111, where the electrically conductive portion 1110 may be electrically connected to the pin section 1114 and the power supply in the main unit 20, to provide electric energy for the heating member 111. Two or more of the electrically conductive portions 1110 may be provided. The electrically conductive portion 1110 and the pin section 1114 form a first connection portion 1115. Therefore, the first connection portion is connected to a position below the spiral section 1113 and located above the mounting bracket 114. In some embodiments, the temperature sensing probe 1131 is located between the first connection portion 1115 and the spiral section 1113 along the axis of the pipe body 112. Preferably, the temperature sensing probe 1131 fits with the inner wall of the pipe body.

It should be noted that the temperature sensing probe 1131 is located above the mounting bracket 114. Because heat conduction conditions at and below the mounting bracket 114 are relatively complex, with significant temperature variations and more influencing factors, generally resulting in hysteresis for temperature sensing by the temperature sensing probe 1131, it is not conducive to characterizing the true heating temperature of the aerosol generating substrate. Moreover, a space is narrow in this zone, which is not conducive to mounting of the temperature sensing probe 1131.

The pipe body 112 is made of a transparent quartz material, the pipe body is of a closed conical shape at an upper end, and is substantially columnar. At least a part of the pipe body is mounted in the lower housing 122, and the opening 1120 is formed in the bottom of the pipe body. The pipe body 112 may be configured to allow the infrared light generated by the heating member 111 to penetrate through and be transferred to the substrate section of the aerosol generating substrate 100, so as to heat the aerosol generating substrate 100 for generating aerosol. It may be understood that, in addition to being made of the transparent quartz material, the pipe body 112 may further be formed from any other materials that are both heat-resistant and effective at transmitting the infrared light, and the pipe body 112 has the transmittance of at least 50% for the infrared light within the wavelength range of 2-4.75 μm. In some embodiments, the pipe body 112 may include an insertion section and a fixed section connected to the insertion section. The fixed section may be configured to be fixed to the lower housing 122. Therefore, at least a part of the pipe body 112 may be inserted into the aerosol generating substrate 100.

The flange 115 is connected to the bottom of the pipe body 112, sleeves the fixed section of the pipe body 112, and is spaced apart from the insertion section by a specific distance, namely, the flange 115 does not come into contact with the aerosol generating substrate 100. The flange 115 is spaced apart from the insertion section, and the position of the temperature sensing probe 1131 corresponds to the position of the spacing. The flange 115 may be configured to fix the pipe body 112, so as to prevent loosening or overstressing at a connection between the pipe body 112 and the lower housing 122, such that the pipe body 112 may be more stably fixed to the lower housing 122. The flange 115 may further be configured to fix the temperature sensing member 113, namely, the temperature sensing member 113 is fixed to the outside of the pipe body 112, such that the temperature sensing member 113 may more directly sense the temperature of the aerosol generating substrate 100, thereby facilitating adjustment in the temperature of the heating component 11.

In some embodiments, the mounting bracket 114 may include a longitudinal mounting bracket body 1140 and a first mounting slot 1141 disposed in the mounting bracket body 1140, where the first mounting slot 1141 is disposed on the outer surface of the mounting bracket body 1140 and extends along a length direction of the mounting bracket body 1140. One, two, three, or more first mounting slots 1141 may be provided. The electrically conductive portion 1110 and the temperature sensing lead 1132 may be mounted in the first mounting slot 1141, and connected to the main unit 20 through the first mounting slot 1141. In some embodiments, the four first mounting slots 1141 are provided, where two of the first mounting slots are respectively provided with the two electrically conductive portions 1110, while the other two mounting slots are configured to mount the temperature sensing leads 1132. Additionally, when the two electrically conductive portions 1110 are provided, a mounting hole may be disposed in the middle of the mounting bracket body 1140 for the two electrically conductive portions 1110 to pass through. In some embodiments, the three first mounting slots 1141 are provided, where the two electrically conductive portions 1110 and the temperature sensing lead 1132 are respectively mounted in the three first mounting slots. It may be understood that, when the temperature sensing member 113 is mounted outside the pipe body 112, the two electrically conductive portions 1110 may respectively pass through the flange 115.

In some embodiments, a plurality of first mounting slots 1141 are disposed at intervals and extend through upper and lower surfaces of the mounting bracket body 1140. Therefore, a plurality of leads mounted in the first mounting slots 1141 do not interfere with each other. It may be understood that the plurality of first mounting slots 1141 may alternatively be arranged in parallel and at intervals.

The temperature sensing probe 1131 is located at an upper end of the mounting bracket 114 (one end far away from the opening 1120 of the pipe body 112), and is higher than the upper end face of the mounting bracket 114 in a vertical direction. The distance between the temperature sensing probe 1131 and the upper end face of the mounting bracket 114 is less than or equal to 5 mm. The specific position of the temperature sensing probe 1131 is related to the position of the heating base 1111, and the temperature sensing probe is located at a bottom end of the heating member 111, thereby effectively reducing the impact of high temperature generated by the heating base 1111 on the temperature sensing effect of the temperature sensing probe 1131.

Since the mounting bracket 114 is mounted in the pipe body 112, and the first mounting slot 1141 is disposed on the outer surface of the mounting bracket body 1140, a first mounting space 1142 may be formed between the first mounting slot 1141 and the inner wall surface of the pipe body 112. The electrically conductive portion 1110 and the temperature sensing lead 1132 may be mounted in the first mounting space 1142. Specifically, since the temperature sensing lead 1132 may be mounted inside or outside the pipe body 112, when the temperature sensing lead 1132 is mounted inside the pipe body 112, the temperature sensing lead 1132 is mounted in the first mounting space 1142.

In some embodiments, the flange 115 may include a flange body 1150 and a mounting port 1151 which is disposed in the middle of the flange body 1150 and extends up and down through the flange body 1150. The mounting port 1151 is of a round shape, and may cooperate with the bottom of the pipe body 112, such that the pipe body 112 may be fixed in the flange 115.

In some embodiments, the flange 115 may further include a second mounting slot 1152, where the second mounting slot 1152 is formed in the inner wall surface of the mounting port 1151, is in communication with the mounting port 1151, and extends up and down through upper and lower surfaces of the flange body 1150. When the temperature sensing member 113 is mounted outside the pipe body 112, the second mounting slot 1152 may be configured to accommodate the temperature sensing lead 1132 of the temperature sensing member 113.

Since the pipe body 112 is mounted in the mounting port 1151 of the flange 115, the outer wall surface of the pipe body and the second mounting slot 1152 jointly define a second mounting space 1153. When the temperature sensing member 113 is disposed outside the pipe body 112, the temperature sensing lead 1132 is mounted in the second mounting space 1153.

The temperature sensing probe 1131 is in close contact with the outer wall of the pipe body 112, is located above an upper end of the flange 115 and specifically at the height greater than 2 mm from the upper end surface of the flange 115 (the distance to the flange 115 is greater than or equal to 2 mm), and does not come into contact with the aerosol generating substrate 100 (remaining below the insertion section), so as to avoid the temperature sensing probe 1131 from being too far away from the aerosol generating substrate 100 to sense the temperature of the aerosol generating substrate, and prevent interference with the aerosol generating substrate 100. The temperature sensing probe 1131 does not extend beyond the bottom of the aerosol generating substrate 100 mounted on the heating component 11, namely, is located below the insertion section of the pipe body 112 (at the distance greater than or equal to 0 mm), thereby avoiding damage or displacement of the temperature sensing probe 1131 caused by insertion or removal. During a consumer's vaping process, heat is carried away from the aerosol generating substrate 100 promptly. Consequently, the temperature sensing probe 1131 disposed at the position may provide feedback on temperature variations with greater accuracy and timeliness. This, in turn, allows for more precise temperature control, thereby achieving a better heating and atomization effect.

Since the leads mounted in the first mounting space 1142 and the second mounting space 1153 are not in close contact with the mounting space, and elements such as the K-type thermocouple have certain flexibility, if the leads are not fixed, deviations from intended positions of the leads may occur, leading to abnormal temperature sensing readings or localized overheating. Therefore, the first mounting space 1142 and the second mounting space 1153 may be filled with high-temperature adhesives to fix the leads mounted therein. It may be understood that other fixing means than filling with high-temperature adhesives, such as addition of fixing blocks, may also be applicable.

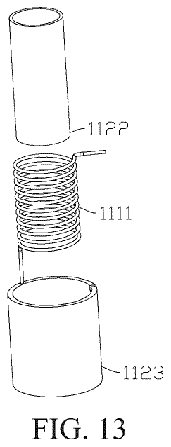

Referring to FIG. 11 to FIG. 13 together, in some embodiments, the heating component 11 may further be tubular in shape, in which case the tubular heating component 11 is a circumferential heating element, as opposed to being configured as a needle-like central heating member to heat the aerosol generating substrate 100. The pipe body 112 of the heating component 11 is of a double-layered tubular arrangement, and includes an accommodating cavity 1121 for accommodating at least a part of the aerosol generating substrate 100. At least a part of the aerosol generating substrate 100 is mounted in the accommodating cavity 1121, and the temperature sensing probe 1131 is disposed inside or outside the pipe body 112.

When the temperature sensing probe 1131 is disposed inside the pipe body 112, the temperature sensing probe 1131 may be specifically disposed at the bottom of the accommodating cavity 1121; and when the temperature sensing probe 1131 is disposed outside the pipe body 112, the temperature sensing probe 1131 is disposed outside the pipe body 112 and is in close contact with the outer wall surface of the pipe body 112.

In some embodiments, in the tubular heating component 11, the pipe body 112 includes a first pipe body 1122 and a second pipe body 1123 that spacedly sleeves the first pipe body 1122. The heating base 1111 may be spaced between the first pipe body 1122 and the second pipe body 1123, and be spaced apart from the outer wall of the first pipe body 1122 to prevent the aerosol generating substrate 100, which is mounted inside the second pipe body 1123, from being scorched by localized overheating, as this may otherwise impair the consumer's vaping experience. In some embodiments, the temperature sensing probe 1131 may be disposed on the inner wall of the second pipe body 1123, and is fixed to the inner wall surface of the second pipe body 1123 by the high-temperature adhesive or the like.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating component, comprising:
an infrared light transmitting pipe body; and
a heating member configured to generate infrared light,
wherein the infrared light transmitting pipe body includes an opening, and the heating member is disposed in the infrared light transmitting pipe body and at least partially spaced apart from a pipe wall of the infrared light transmitting pipe body, and
wherein the heating component further comprises a temperature sensing member comprising a temperature sensing probe disposed between the heating member and the opening.

2. The heating component of claim 1, wherein the heating member comprises a heating base and an infrared radiating layer,
wherein the infrared radiating layer is disposed on the heating base, and
wherein the temperature sensing probe is disposed between the heating base and the opening.

3. The heating component of claim 2, wherein the infrared light transmitting pipe body is configured to be at least partially insertable into an aerosol generating substrate, and
wherein the temperature sensing member is disposed inside the infrared light transmitting pipe body.

4. The heating component of claim 3, further comprising:
a mounting bracket that passes through the opening and is disposed in the infrared light transmitting pipe body,
wherein the temperature sensing member comprises a temperature sensing lead connected to the temperature sensing probe,
wherein the temperature sensing lead is fixed to the mounting bracket, and
wherein the temperature sensing probe is located at one end of the mounting bracket that is far away from the opening and is higher than the end surface of one end of the mounting bracket that is far away from the opening in a vertical direction.

5. The heating component of claim 4, wherein the heating base comprises a spiral section,
wherein the heating member comprises a pin section connected to one end of the spiral section that is oriented toward the opening, and
wherein a vertical projection of the temperature sensing probe onto an axis of the infrared light transmitting pipe body at least partially overlaps with a vertical projection of the pin section onto an axis of the infrared light transmitting pipe body.

6. The heating component of claim 3, wherein the heating base comprises a spiral section,
wherein the heating member comprises an electrically conductive portion and a pin section connected to one end of the spiral section that is oriented toward the opening,
wherein a first connection portion is formed between the electrically conductive portion and the pin section, and
wherein the temperature sensing probe is disposed between the first connection portion and the spiral section.

7. The heating component of claim 1, wherein the temperature sensing member is in close contact with an inner wall of the infrared light transmitting pipe body.

8. The heating component of claim 5, wherein the temperature sensing probe is in close contact with the pin section.

9. The heating component of claim 7, wherein a portion of the temperature sensing lead that is located between the temperature sensing probe and the mounting bracket comprises at least one bending section.

10. The heating component of claim 4, wherein a distance between the temperature sensing probe and a top of the heating member is greater than or equal to 8 mm and less than or equal to 20 mm.

11. The heating component of claim 4, wherein a distance between the temperature sensing probe and one end of the mounting bracket that is far away from the opening is less than or equal to 5 mm.

12. The heating component of claim 1, wherein the infrared light transmitting pipe body is configured to be at least partially insertable into an aerosol generating substrate,
wherein the temperature sensing member is disposed outside the infrared light transmitting pipe body, and
wherein the temperature sensing probe is in close contact with an outer wall of the infrared light transmitting pipe body.

13. The heating component of claim 12, wherein the infrared light transmitting pipe body comprises an insertion section and a fixed section connected to the insertion section,
wherein the heating component comprises a flange,
wherein the flange is fixed to the fixed section and is spaced apart from the insertion section, and
wherein the temperature sensing probe corresponds to the spacing.

14. The heating component of claim 13, wherein a distance between the temperature sensing probe and the flange is greater than or equal to 2 mm, and
wherein a distance between the temperature sensing probe and the insertion section is greater than or equal to 0 mm.

15. The heating component of claim 1, wherein the temperature sensing member comprises a thermocouple or a negative temperature coefficient temperature sensing element.

16. The heating component of claim 1, wherein an accommodating cavity for accommodating at least a part of an aerosol generating substrate is formed in the infrared light transmitting pipe body, and
wherein the temperature sensing probe is disposed at a bottom of the accommodating cavity or outside the infrared light transmitting pipe body.

17. The heating component of claim 16, wherein the infrared light transmitting pipe body comprises a first pipe body and a second pipe body that sleeves the first pipe body,
wherein the heating member is spaced between the first pipe body and the second pipe body and is spaced apart from an outer wall of the first pipe body, and
wherein the temperature sensing probe is disposed on an inner wall of the second pipe body.

18. An aerosol generating device, comprising:
the heating component of claim 1.
